(19) United States
(12) Patent Application Publication
(10) Pub. No.: US 2025/0187989 A1
(43) Pub. Date: Jun. 12, 2025

(54) HIGH-TEMPERATURE RESISTANT AND LONG-LASTING NON-STICK CERAMIC COATING AND PREPARATION METHOD THEREOF

(71) Applicant: SHANGHAI EXCILON NEW MATERIAL CO., LTD., Shanghai (CN)

(72) Inventors: Qinyang YU, Shanghai (CN); Lifeng LI, Shanghai (CN); Jie ZHAO, Shanghai (CN); Yang LIU, Shanghai (CN); Yali ZHANG, Shanghai (CN)

(21) Appl. No.: 19/059,494

(22) Filed: Feb. 21, 2025

Related U.S. Application Data
(63) Continuation of application No. PCT/CN2023/113328, filed on Aug. 16, 2023.

(30) Foreign Application Priority Data
Aug. 30, 2022 (CN) 202211048064.X

(51) Int. Cl. C04B 35/622; B01J 13/08; C04B 35/14; C04B 41/45

(52) U.S. Cl. CPC C04B 35/62222; B01J 13/08; C04B 35/14; C04B 41/4537; C04B 2235/3418; C04B 2235/963

(57) ABSTRACT

Disclosed is a high-temperature resistant and long-lasting non-stick ceramic coating and a preparation method thereof. The coating includes a primer and a top coating, based on a total weight of the primer being 100%, the primer comprises: silica sol: 26-28%, 1% NaOH solution: 4-5%, pigment: 10-12%, filler: 8-10%, dispersant: 1-1.5%, silane: 28-30%, isopropanol: 3-3.5%, silicone oil microcapsule: 3-4%, 25% formic acid solution: 0.7-1%, the balance being deionized water; based on a total weight of the top coating being 100%, the top coating comprises: silica sol+silane: 82-85%, silicone oil microcapsule: 6-8%, leveling agent: 1-1.5%, 25% formic acid solution: added until a pH value of the top coating is the same as that of the primer, the balance being isopropanol. The ceramic coating has an inorganic structure in its main molecular chain, which features high-temperature resistance, high hardness, and good wear resistance in addition to the long-lasting non-stick property.

### CROSS-REFERENCE TO RELATED APPLICATION

The present application is a continuation of PCT application serial No. PCT/CN2023/113328, filed on Aug. 16, 2023, which claims the priority and benefit to China application serial No. 202211048064.X, filed on Aug. 30, 2022. The entireties of PCT application serial No. PCT/CN2023/113328 and China application serial No. 202211048064.X are incorporated herein by reference and made a part of this specification.

### TECHNICAL FIELD

The present application is in the technical field of coatings, and relates to a high-temperature resistant and long-lasting non-stick ceramic coating and a preparation method thereof.

### BACKGROUND ART

In recent years, due to the obvious advantages in terms of health, safety, and environmental friendliness, ceramic coatings, as non-stick coatings, are increasingly applied to the inner surface of non-stick pans. The non-stick property of the surface of ceramic coatings is provided by means of the low surface energy of —CH₃ groups. The sources of —CH₃ groups in ceramic coatings are as follows: (1) the —CH₃ groups carried on the molecular chain of silane when a sol-gel reaction takes place between silica sol and silane under acidic conditions; (2) silicone oil added to ceramic coatings, which is a polyorganosiloxane with a chain structure of different degrees of polymerization, contains a large number of —CH₃ groups on the molecular chain, and is commonly used to enhance the non-stick property of coatings. During the sol-gel reaction of ceramic coatings, the number of —CH₃ groups on the molecular chain of silane is far from the requirement of the non-stick durability of the coatings. Therefore, the non-stick property of ceramic coatings is mainly provided by the silicone oil to be added. However, since the density of silicone oil is lower than that of ceramic coatings, and silicone oil has good compatibility with solvents but relatively poor compatibility with water-based ceramic coatings, the silicone oil to be added generally floats on the top of the coatings and is located on the surface of the coatings after curing. Moreover, the amount of silicone oil added to ceramic coatings should not be too large, generally being 2-3%. If the amount of silicone oil added is too large, floating oil may occur on the surface of the coatings after curing, affecting the appearance of the coatings. During use, the silicone oil on the surface of ceramic coatings will gradually lose the non-stick property with continuous friction or the breaking of chemical bonds at high temperatures. Since the amount of silicone oil added is not large, the non-stick property may generally be maintained for only about half a year. Such service life is far from the user's expectations.

The loss of the non-stick property of ceramic coatings is mainly attributed to two factors: (1) the friction from food materials or turners on the coatings during use causes the —CH₃ bonds to break, gradually resulting in the loss of the non-stick property; (2) the —CH₃ bonds occur break at high temperatures, resulting in the loss of the non-stick property, especially when dry-burning or scorching in the pan, the non-stick property will suddenly loss. Conventional techniques for improving the non-stick durability of ceramic coatings mainly focus on increasing the wear resistance of the coatings. Through searching the existing patent documents, it is found that the Chinese Patent ZL201711 124381.4 discloses a technical solution for a wear-resistant non-stick ceramic coating, which improves the non-stick durability of the coating by adding a diamond powder to the formula to improve the wear resistance of the coating. The testing for the non-stick property shows that the test of frying eggs without oil after high temperature can only be achieved for 5-6 cycles, and the actual service life is also within 1 year. How to essentially solve the compatibility between silicone oil and water-based ceramic coatings, increase the amount of silicone oil added, and enable silicone oil to uniformly disperse in the coatings is the key to solving the non-stick durability of ceramic coatings.

### SUMMARY

In view of the problems existing in the prior art, such as the silicone oil that provides the non-stick property in water-based ceramic coatings has low density, poor compatibility with the water-based coatings, floats on the surface of the coatings, cannot be uniformly dispersed in the coatings, and cannot be added in too large amount and continuously play the non-stick effect, thereby resulting in poor non-stick durability of the ceramic coatings, the object of the present application is to provide a high-temperature resistant and long-lasting non-stick ceramic coating and a preparation and application method thereof. The present application essentially solves the compatibility between silicone oil and water-based ceramic coatings, so that the silicone oil can be uniformly dispersed in the coatings, and increases the amount of silicone oil added, which is the key to solving the non-stick durability of ceramic coatings.

The object of the present application is achieved by the following technical solutions.

### First Aspect

The present application relates to a high-temperature resistant and long-lasting non-stick ceramic double-layer coating, including a primer and a top coating,
based on a total weight of the primer being 100%, the primer including the following components in percentage by weight:
silica sol: 26-28%, 1% NaOH solution: 4-5%, pigment: 10-12%, filler: 8-10%, dispersant: 1-1.5%, silane: 28-30%, isopropanol: 3-3.5%, silicone oil microcapsule: 3-4%, 25% formic acid solution: 0.7-1%, the balance being deionized water;
based on a total weight of the top coating being 100%, the top coating including the following components in percentage by weight:
silica sol+silane: 82-85%, silicone oil microcapsule: 6-8%, leveling agent: 1-1.5%, 25% formic acid solution: added until a pH value of the top coating is the same as that of the primer, the balance being isopropanol; and a mass ratio of the silica sol to the silane is 1.5-1.2:1.

In the primer, the silica sol is the main film-forming substance of the ceramic coating and is a common commercially available product, such as Bindzil 2034DI from AkzoNobel, ST-O-40 from Nissan Chemical, and Grace LUDOX® HS-40.

In the primer, the 1% NaOH solution is used as a pH regulator for a color paste to adjust a pH value of the color paste to 9-10.5. After the silica sol is ground into the color paste, the pH value will decrease during storage. Upon the pH value decreases below 8.5 and approaches neutrality, the silica sol will gel, leading to the deterioration of the color paste. Therefore, it is necessary to adjust the pH value of the color paste to 9-10.5 with an alkaline solution, so as to ensure that the color paste will not deteriorate during storage.

In the primer, the pigment imparts different colors to the coating and is selected from common inorganic pigments. The inorganic pigments have good temperature resistance and safety and are suitable for the field of high-temperature resistance. The pigment can be, for example, titanium dioxide, ferromanganese black, iron oxide yellow, iron oxide red, cobalt blue, etc.

In the primer, the filler functions to reduce the cost of the coating and increase a solid content of the coating and is selected from common fillers, such as a mica powder, a silica micropowder, kaolin, an alumina powder, fumed silica, etc.

In the primer, the dispersant, such as BYK180, BYK190, BYK2010, and BYK2001, functions to reduce a dispersion time of the pigment and the filler, stabilize a pigment dispersion, and improve a coloring and hiding power of the pigment.

In the primer, the silane is an auxiliary film-forming substance and can be one or more selected from a group consisting of: methyl trimethoxysilane, methyl triethoxysilane, dimethyl dimethoxysilane, and dimethyl diethoxysilane.

In the primer, the silicone oil microcapsule is a component that provides the primer of the ceramic coating with the non-stick property and is a shell-core structural microcapsule. During a heating process of the coating, the silicone oil can gradually diffuse out of the shell structure, slowly release the non-stick property, and prolong the non-stick durability of the coating.

In the primer, the 25% formic acid solution is a catalyst for the sol-gel reaction of the ceramic coating. The silane is hydrolyzed under acidic conditions and then undergoes a polycondensation reaction with the silica sol to produce the ceramic coating.

In the top coating, the silica sol is the main film-forming substance of the ceramic coating and is a common commercially available product, such as Bindzil 2034DI from AkzoNobel, ST-O-40 from Nissan Chemical, and Grace LUDOX® HS-40.

In the top coating, the silane is an auxiliary film-forming substance and can be selected from a group consisting of: methyl trimethoxysilane, methyl triethoxysilane, dimethyl dimethoxysilane, and dimethyl diethoxysilane.

A molecular structure formed by the sol-gel reaction depends mainly on types of silica sol and silane, the ratio of silica sol to silane, the pH value of the reaction, and other factors. The silica sol and the silane in the top coating are of the same type and in the same ratio as those in the primer, thus enabling the top coating to form the same molecular structure as the primer, which facilitates the silicone oil in the primer gradually diffusing out of the shell-core structural microcapsule at high temperatures, migrating into the top coating, and continuously providing the non-stick property.

In the top coating, the silicone oil microcapsule is a component that provides the top coating of the ceramic coating with the non-stick property and is the shell-core structural microcapsule. During the heating process of the coating, the silicone oil can gradually diffuse out of the shell structure, slowly release the non-stick property, and prolong the non-stick durability of the coating. In the present application, the silicone oil microcapsule is added to both the top coating and the primer. The silicone oil microcapsule in the top coating provides an initial non-stick property. Since the top coating is thin and a content is not high, the silicone oil in the primer can be released after the silicone oil in the top coating is consumed to continuously provide the non-stick property.

In the top coating, the leveling agent is used to facilitate the coating forming a flat, smooth, and uniform film during the drying and film-forming process. The leveling agent can be, for example, BYK-333 and Dow Corning DC-57.

In the top coating, the 25% formic acid solution is a catalyst for the sol-gel reaction of the ceramic coating. The silane is hydrolyzed under acidic conditions and then undergoes a polycondensation reaction with the silica sol to produce the ceramic coating.

As an embodiment, based on a total weight of the silicone oil microcapsule being 100%, the silicone oil microcapsule includes the following components:
silicone oil: 43-45%,
silane: 48-50%,
surfactant: 4-4.5%,
the balance being 25% formic acid solution.

In the silicone oil microcapsule, the silicone oil is used to provide the non-stick property of the primer of the ceramic coating and is selected from common silicone oil, such as methyl silicone oil and hydroxyl silicone oil.

In the silicone oil microcapsule, the silane is composed of a trifunctional silane and a difunctional silane in a mass ratio of 1:1-2:1. The trifunctional silane includes methyl trimethoxysilane and methyl triethoxysilane; the difunctional silane includes dimethyl dimethoxysilane, dimethyl diethoxysilane, etc. The trifunctional silane and difunctional silane need to be used in combination in the silicone oil microcapsule, so that a regular three-dimensional cross-linked network structure can be formed and the network has a relatively large diameter, which is conducive to the diffusion of silicone oil. If only trifunctional silane is used, the cross-linked network structure formed is denser and the network has a smaller diameter, which is not conducive to the out-diffusion of silicone oil. The use of short-chain alkyl silane can avoid premature polymerization and steric-hindrance effect, so that the shell structure is more complete and regular. Long-chain alkyl silane is prone to generate the steric-hindrance effect in the early stage of polymerization, making it difficult to form a complete shell structure during polymerization. Moreover, when the mass ratio of the trifunctional silane to the difunctional silane is greater than 2:1, too much trifunctional silane results in the cross-linked network structure formed being denser and the network has a smaller diameter, which is not conducive to the out-diffusion of silicone oil; when the mass ratio is less than 1:1, too much difunctional silane is not conducive to the formation of a complete cross-linked network structure, many linear-structural chain segments will be produced, causing the silicone oil to be released too quickly. As a result, floating oil may occur on the coating, and the non-stick durability will be poor.

In the silicone oil microcapsule, the surfactant is selected from an cationic surfactant, which can exist stably under weakly acidic conditions. The cationic surfactant is a surfactant with an organic quaternary ammonium salt structure, such as cetyltrimethylammonium bromide, stearyldimethylbenzylammonium chloride, benzalkonium chloride, benzalkonium bromide, etc. In the system of the present application, if anionic surfactants are added, gelation occurs; if nonionic surfactants are added, the stabilization effect is not satisfactory.

In the silicone oil microcapsule, the 25% formic acid solution is used as a catalyst for the hydrolysis of the silane. The silane can be hydrolyzed under acidic conditions to form a colorless and clear solution.

The silicone oil microcapsules are prepared by: uniformly mixing the silicone oil, the silane, and the surfactant, adjusting a pH value of a resulting mixture to 4.0-5.0 with the 25% formic acid solution with stirring, reacting for 4-6 h, and then sonicating for 2 h to obtain the silicone oil microcapsule. The microcapsule has a shell-core structure, wherein the shell is a three-dimensional cross-linked network structure of Si—O—Si formed after the hydrolytic and polymerization of the silane under acidic conditions, and the core is the silicone oil emulsified with the surfactant. The reticulated shell structure allows the silicone oil inside to slowly diffuse out.

Due to the effect of the surfactant, the silicone oil microcapsule can be uniformly dispersed in the coating, and can also be uniformly distributed in the coating after curing. When the silicone oil on the upper layer (here it refers to the silicone oil in the upper part of the coating since the silicone oil microcapsules are uniformly distributed in the coating) loses its function during use, the silicone oil inside the coating can slowly diffuse out at high temperatures to continue providing the non-stick property, ensuring the long-lasting non-stick property of the coating. If the silicone oil is directly added to the ceramic coating, due to its low density and poor compatibility with water-based coatings, the silicone oil only floats on the surface of the coating, and the silicone oil remains on the surface layer of the coating after curing and film-forming. Once the function of the silicone oil is lost, the non-stick property disappears immediately. Therefore, the non-stick durability of the coating with the silicone oil added directly is poor.

This step is carried out by means of reacting for 4-6 hours with stirring and then sonicating for 2 hours. The reaction with stirring is mainly to generate the shell structure, and the silicone oil and the surfactant are preliminarily combined. The silicone oil and the surfactant are further emulsified under sonication to form a uniform and stable silicone oil microcapsule dispersion.

### Second Aspect

The present application relates to a preparation method of the high-temperature resistant and long-lasting non-stick ceramic double-layer coating, including the following steps:
A1, preparation of a color paste of the primer: uniformly mixing the silica sol, the pigment, the filler, the dispersant, and deionized water in the primer, adjusting a pH value of a resulting mixture to 9.5-10.5 with a 1% NaOH solution, and then grinding the resulting mixture to a fineness below 20 μm;
A2, preparation of the primer of the ceramic coating: uniformly mixing the silane, isopropanol, the silicone oil microcapsule, and 25% formic acid solution in the primer, then adding the color paste prepared in step A1, uniformly mixing, and reacting for 4-8 hours to obtain the primer of the ceramic coating; and
A3, preparation of the top coating of the ceramic coating: uniformly mixing the silane, isopropanol, the silicone oil microcapsule, and leveling agent in the top coating, gradually adding 25% formic acid solution, measuring a pH value of a resulting solution and adjusting the pH value to be the same as that of the primer (to ensure that the top coating and the primer have the same pH reaction conditions as much as possible), then adding the silica sol, uniformly mixing, reacting for the same time as the primer, and then measuring the pH value every half an hour until the pH value is stable to obtain the top coating of the ceramic coating.

In step A1, after grinding the resulting mixture to a fineness below 20 μm, the pH value of the color paste is remeasured. If the pH value is less than 9.0, it is adjusted to 9.0-10.0 with the 1% NaOH solution for later use.

In step A3, the molecular structure formed by the sol-gel reaction depends mainly on the types of silica sol and silane, the ratio of silica sol to silane, the pH value of the reaction, and other factors. In the preparation process of the top coating, strictly controlling the pH value is to achieve the same pH reaction conditions as those of the primer. During the sol-gel reaction, the pH value exhibits a trend of gradually increasing first and then stabilizing. In general, the sol-gel reaction time for the top coating is about 2 hours longer than that of the primer, because the primer contains the pigment and the filler in addition to film-forming substances, resulting in a high solid content, a high probability of molecular collisions during the reaction, and a fast reaction speed, while the top coating has a low solid content, resulting in a low probability of molecular collisions during the reaction and a slow reaction speed, so it is necessary to increase the reaction time to achieve the same reaction degree as the primer.

In the system according to the application, it is preferred that the pH values of the top coating and the primer are substantially the same, i.e., with an error of ±0.2. If there is a significant difference in pH values between the top coating and the primer, the difference between the network structures formed by the primer and the top coating is large, i.e., the difference between the network pore sizes is large. When the network pore size of the top coating is too small, the release of the silicone oil is too slow, resulting in poor non-stick durability of the coating; when the network pore size of the top coating is too large, the release of the silicone oil is too fast and the consumption of the silicone oil is too fast, which likewise results in poor non-stick durability of the coating.

The present application has the following beneficial effects as compared with the prior art.
(1) By the hydrolytic and polymerization of silane and the emulsification of silicone oil with the surfactant, the silicone oil microcapsules with a shell-core structure are prepared, in which the shell is a three-dimensional cross-linked network structure of Si—O—Si formed by the hydrolytic and polymerization of silane, and the core is the silicone oil emulsified with the surfactant. The shell-core structure makes the silicone oil has good compatibility with the water-based ceramic coating, can be uniformly dispersed throughout the ceramic coating, and can also be uniformly distributed throughout the coating after curing. The silicone oil can slowly diffuse out at high temperatures, so that the silicone oil can continuously provide the non-sticky property. The silicone oil microcapsule with the shell-core structure can further increase the amount of silicone oil added, resulting in better non-stick durability of the coating.
(2) The film-forming substances of the primer and the top coating are of the same type, in the same ratio, and subjected to the same reaction conditions, so that the primer and the top coating form the same molecular structure as much as possible during curing. When the silicone oil in the top coating is depleted and loses the non-stick effect, it facilitates the silicone oil in the primer diffusing out of the microcapsule with the shell-core structure, slowly migrating into the top coating, and continuously playing the non-stick effect. The non-stick durability of the non-stick ceramic coating prepared by this method can last more than 2 years.
(3) The long-lasting non-stick ceramic coating according to the present application has an inorganic structure in the main molecular chain, which features high-temperature resistance, high hardness, and good wear resistance in addition to the long-lasting non-stick property.

### DETAILED DESCRIPTION

The present application is described in detail below with reference to Examples. The following Examples will help those skilled in the art to further understand the present application and are not intended to limit the present application in any way. It should be noted that several adaptations and improvements can be made by those of ordinary skill in the art without departing from the concepts of the present application. These are all within the scope of the present application.

### Examples 1 to 6

Examples 1 to 6 provide a high-temperature resistant and long-lasting non-stick ceramic coating having the composition shown in Table 1.

The primer of the ceramic coating was prepared as follows.

(1) Preparation of a color paste: silica sol, a pigment, a filler, a dispersant, and deionized water were uniformly mixed to obtain a resulting mixture. A pH value of the resulting mixture was adjusted to 10 with a 1% NaOH solution, and then the resulting mixture was ground to a fineness below 20 μm. The pH value of the color paste was remeasured. If the pH value was less than 9.0, it was adjusted to 10.0 with the 1% NaOH solution for later use.

(2) Preparation of the primer of the ceramic coating: silane, isopropanol, silicone oil microcapsules, and a 25% formic acid solution were uniformly mixed to obtain a resulting solution. A pH value of the resulting solution was measured and recorded. Then, the color paste prepared in step (1) was added, uniformly mixed, and reacted on a roller stand for 6 hours to obtain the primer of the ceramic coating. The pH value of the primer was measured and recorded, all of which were between 4.0 and 5.0.

The top coating of the ceramic coating was prepared as follows.

Silane, isopropanol, silicone oil microcapsules, and a leveling agent were uniformly mixed to obtain a resulting solution, and a 25% formic acid solution was gradually added. A pH value of the resulting solution was measured. The pH value was adjusted to be the same as that of the primer to ensure that the top coating and the primer have the same pH reaction conditions as much as possible. Then, silica sol was added, uniformly mixed, and reacted on a roller stand for the same time as the primer. The pH value was then measured every half an hour until the pH value was the same as that of the primer to obtain the top coating of the ceramic coating.

### Comparative Example 1

Comparative Example 1 provides a ceramic coating having the composition shown in Table 1.

The primer of the ceramic coating was prepared as follows.
(1) Preparation of a color paste: silica sol, a pigment, a filler, a dispersant, and deionized water were uniformly mixed to obtain a resulting mixture. A pH value of the resulting mixture was adjusted to 10 with a 1% NaOH solution, and then the resulting mixture was ground to a fineness below 20 μm. The pH value of the color paste was remeasured. If the pH value was less than 9.0, it was adjusted to 10.0 with the 1% NaOH solution for later use.
(2) Preparation of the primer of the ceramic coating: silane, isopropanol, hydroxyl silicone oil, a surfactant (benzalkonium chloride), and a 25% formic acid solution were uniformly mixed to obtain a resulting solution. A pH value of the resulting solution was measured and recorded. Then, the color paste prepared in step (1) was added, uniformly mixed, and reacted on a roller stand for 6 hours to obtain the primer of the ceramic coating. The pH value of the primer was measured and recorded.

The top coating of the ceramic coating was prepared as follows.

Silane, isopropanol, hydroxyl silicone oil, a surfactant (benzalkonium chloride), and a leveling agent were uniformly mixed to obtain a resulting solution, and a 25% formic acid solution was gradually added. A pH value of the resulting solution was measured. The pH value was adjusted to be the same as that of the primer to ensure that the top coating and the primer have the same pH reaction conditions as much as possible. Then, silica sol was added, uniformly mixed, and reacted on a roller stand for the same time as the primer. The pH value was then measured every half an hour until the pH value was the same as that of the primer to obtain the top coating of the ceramic coating.

### Comparative Examples 2 to 6

Comparative Examples 2 to 6 provide a ceramic coating having the composition shown 5 in Table 1, which was prepared in the same way as Example 1.

TABLE 1
Compositions and amounts (wt. %) of coatings
in Examples and Comparative Examples

| | Examples | | | | | | Comparative Examples | | | | | |
|---|---|---|---|---|---|---|---|---|---|---|---|---|
| | 1 | 2 | 3 | 4 | 5 | 6 | 1 | 2 | 3 | 4 | 5 | 6 |
| Primer | | | | | | | | | | | | |
| Bindzil 2034DI | 26 | | 27 | | 28 | | 26 | 26 | 26 | 26 | 26 | 26 |
| ST-O-40 | | 28 | | 26 | | 28 | | | | | | |
| 1% NaOH solution | 4 | 4.5 | 5 | 4 | 4 | 4 | 4 | 4 | 4 | 4 | 4 | 4 |
| Pigment titanium dioxide | 10 | 12 | 11 | 10 | 10 | 10 | 10 | 10 | 10 | 10 | 10 | 10 |
| Mica powder | 10 | 4 | | 10 | 10 | 10 | 10 | 10 | 10 | 10 | 10 | 10 |
| Fumed silica | | 4 | 9 | | | | | | | | | |
| BYK2010 | 1 | 1 | 1 | 1 | 1 | 1 | 1 | 1 | 1 | 1 | 1 | 1 |
| Methyl trimethoxysilane | 28 | | | | 28 | | 28.72 | 28 | 28 | 28 | 28 | 28 |
| Methyl triethoxysilane | | 29 | | | | | | | | | | |
| Dimethyl dimethoxysilane | | | 30 | 28 | | | 0.72 | | | | | |
| Dimethyl diethoxysilane | | | | | | 28 | | | | | | |
| Hydroxyl silicone oil | | | | | | | 1.29 | | | | | |
| Benzalkonium chloride | | | | | | | 0.12 | | | | | |
| Isopropanol | 3 | 3 | 3 | 3 | 3 | 3 | 3 | 3 | 3 | 3 | 3 | 3 |
| Silicone oil microcapsule 1 | 3 | 4 | 3.5 | 3 | 3 | 3 | | | | | | |
| Silicone oil microcapsule 2 | | | | | | | | 3 | | | | |
| Silicone oil microcapsule 3 | | | | | | | | | 3 | | | |
| Silicone oil microcapsule 4 | | | | | | | | | | 3 | | |
| Silicone oil microcapsule 5 | | | | | | | | | | | 3 | |
| Silicone oil microcapsule 6 | | | | | | | | | | | | 3 |
| 25% Formic acid solution | 1 | 1 | 1 | 10 | 1 | 1 | 1.15 | 1 | 1 | 1 | 1 | 1 |
| Deionized water | Balance | | | | | | | | | | | |
| Top coating | | | | | | | | | | | | |
| Bindzil 2034DI | 39 | | 40 | 39 | 39 | 39 | 39 | 39 | 39 | 39 | 39 | 39 |
| ST-O-40 | | 41.5 | | | | | | | | | | |
| Methyl trimethoxysilane | 42 | | | 42 | 42 | 42 | 43.44 | 42 | 42 | 42 | 42 | 42 |
| Methyl triethoxysilane | | 43 | | | | | | | | | | |
| Dimethyl dimethoxysilane | | | 44.5 | | | | 1.44 | | | | | |
| Hydroxyl silicone oil | | | | | | | 2.58 | | | | | |
| Benzalkonium chloride | | | | | | | 0.24 | | | | | |
| Silicone oil microcapsule 1 | 6 | 7 | 8 | 6 | 6 | 6 | | | | | | |
| Silicone oil microcapsule 2 | | | | | | | | 6 | | | | |
| Silicone oil microcapsule 3 | | | | | | | | | 6 | | | |
| Silicone oil microcapsule 4 | | | | | | | | | | 6 | | |
| Silicone oil microcapsule 5 | | | | | | | | | | | 6 | |
| Silicone oil microcapsule 6 | | | | | | | | | | | | 6 |
| Dow Corning DC-57 | 1 | 1 | 1 | 1 | 1 | 1 | 1 | 1 | 1 | 1 | 1 | 1 |
| 25% Formic acid solution | 1 | 1 | 1 | 1 | 1 | 1 | 1.3 | 1 | 1 | 1 | 1 | 1 |

| | |
|---|---|
| Isopropanol | Balance |

In I Table 1,
Silicone oil microcapsule 1: 43% hydroxyl silicone oil, 48% silane (methyl trimethoxysilane and dimethyl dimethoxysilane in a mass ratio of 1:1), and 4% surfactant (benzalkonium chloride) were uniformly mixed. A pH value of a resulting mixture was adjusted to 4.5 with a 25% formic acid solution with stirring. The resulting mixture was reacted for 5 h and then sonicated for 2 h to obtain the silicone oil microcapsule 1.
Silicone oil microcapsule 2: 43% hydroxyl silicone oil, 48% silane (methyl trimethoxysilane and methyl triethoxysilane in a mass ratio of 1:1), and 4% surfactant (benzalkonium chloride) were uniformly mixed. A pH value of a resulting mixture was adjusted to 4.5 with a 25% formic acid solution with stirring. The resulting mixture was reacted for 5 h and then sonicated for 2 h to obtain the silicone oil microcapsule 2.
Silicone oil microcapsule 3: 43% hydroxyl silicone oil, 48% silane (dimethyl dimethoxysilane and dimethyl diethoxysilane in a mass ratio of 1:1), and 4% surfactant (benzalkonium chloride) were uniformly mixed. A pH value of a resulting mixture was adjusted to 4.5 with a 25% formic acid solution with stirring. The resulting mixture was reacted for 5 h and then sonicated for 2 h to obtain the silicone oil microcapsule 3.
Silicone oil microcapsule 4: 43% hydroxyl silicone oil, 48% silane (octadecyl trimethoxysilane and dimethyl dimethoxysilane in a mass ratio of 1:1), and 4% surfactant (benzalkonium chloride) were uniformly mixed. A pH value of a resulting mixture was adjusted to 4.5 with a 25% formic acid solution with stirring. The resulting mixture was reacted for 5 h and then sonicated for 2 h to obtain the silicone oil microcapsule 4.
Silicone oil microcapsule 5: 43% hydroxyl silicone oil, 48% silane (methyl trimethoxysilane and dimethyl dimethoxysilane in a mass ratio of 3:1), and 4% surfactant (benzalkonium chloride) were uniformly mixed. A pH value of a resulting mixture was adjusted to 4.5 with a 25% formic acid solution with stirring. The resulting mixture was reacted for 5 h and then sonicated for 2 h to obtain the silicone oil microcapsule 5.
Silicone oil microcapsule 6: 0.25 grams of sodium dodecyl sulfonate and 0.75 grams of alkylphenol ethoxylates were dissolved in 100 g of deionized water, and an oil-phase mixture composed of 10 grams of dimethyl silicone oil, 10 grams of TEOS, and 1.5 grams of octadecyl trimethoxysilane was added. A resulting mixture was pre-emulsified and stirred in an ice-water bath for 15 minutes, and then subjected to ultrasonic fine emulsification using a cell crusher for 20 minutes to obtain a fine emulsion. The fine emulsion was adjusted to a pH value of 7.5 and stirred at high speed for 24 hours at room temperature to obtain the opalescent silicone oil microcapsule 6.

### Main Performance Tests

The coatings prepared in the above Examples and Comparative Examples were subjected to the main performance tests after being applied using the following method. The test items and methods are shown in Table 2, and the test results are shown in Table 3.

Coating application method:
(1) An aluminum alloy substrate was sandblasted to a roughness of Ra =4 μm, cleaned with tap water, and placed in an oven to dry the moisture for later use;
(2) The substrate was pre-heated to 50° C., sprayed with the primer and then directly sprayed with the top coating in a wet-on-wet way, then placed in an oven at 250° C. for 12 minutes, and removed and cooled to room temperature.

TABLE 2

| No. | Test items | Test standards or methods |
|---|---|---|
| 1 | Pencil | Mitsubishi Pencil, angled at 45°, draw 10 mm in |
| | hardness | parallel with a 10N force, repeat the test 5 times |
| 2 | Adhesion | Cross-cut test: use a single-side blade to make parallel |
| | | and vertical incisions on the film, depth through the |
| | | entire film thickness, 2.0 mm incision spacing, use |
| | | 3M-898 adhesive tape to repeatedly stick and uncover |
| | | for 5 times, and check no sawtooth crack on each |
| | | scratch |
| 3 | Saltwater | GB/T 9274-1988, test for three cycles |
| | resistance | |
| 4 | Thermal | 300° C. × 2 min, place into ice-water mixed solution |
| | shock | for one cycle |
| | resistance | |
| 5 | Non-stick | Heat pan at a high temperature of 330-350° C. for 30 |
| | durability | minutes, naturally cool, and fry eggs at 180-200° C. |
| | | for 90 s without oil, with 10 eggs for one cycle |
| 6 | Abrasion | 3.0 Kg pressure, 5 cm × 5 cm scouring pad (3M |
| | resistance | 7447C), soak in 5 g/L detergent solution, rub back |
| | | and forth on the coating, record one back-and-forth |
| | | movement as one time, change the scouring pad |
| | | every 250 times until three scratches exposing the |
| | | substrate appear on the coating. |

TABLE 3

| | | Pencil | | Saltwater | Thermal shock | Non-stick | Abrasion |
|---|---|---|---|---|---|---|---|
| | | hardness | Adhesion | resistance | resistance | durability | resistance |
| Examples | 1 | 9H | Grade 1 | No blistering or | 10 Cycles, no | 15 Cycles | ≥30,000 |
| | | | | shedding of the | cracking or | | times |
| | | | | coating after | shedding of the | | |
| | | | | three cycles | coating | | |
| | 2 | 9H | Grade 1 | No blistering or | 10 Cycles, no | 15 Cycles | ≥30,000 |
| | | | | shedding of the | cracking or | | times |
| | | | | coating after | shedding of | | |
| | | | | three cycles | the coating | | |
| | 3 | 9H | Grade 1 | No blistering or | 10 Cycles, no | 14 Cycles | ≥30,000 |
| | | | | shedding of the | cracking or | | times |
| | | | | coating after | shedding of the | | |
| | | | | three cycles | coating | | |
| | 4 | 9H | Grade 1 | No blistering or | 10 Cycles, no | 13 Cycles | ≥30,000 |
| | | | | shedding of the | cracking or | | times |
| | | | | coating after | shedding of the | | |
| | | | | three cycles | coating | | |
| | 5 | 9H | Grade 1 | No blistering or | 10 Cycles, no | 13 Cycles | ≥30,000 |
| | | | | shedding of the | cracking or | | times |
| | | | | coating after | shedding of the | | |
| | | | | three cycles | coating | | |
| | 6 | 9H | Grade 1 | No blistering or | 10 Cycles, no | 13 Cycles | ≥30,000 |
| | | | | shedding of the | cracking or | | times |
| | | | | coating after | shedding of the | | |
| | | | | three cycles | coating | | |
| Comparative | 1 | 9H | Grade 1 | No blistering or | 10 Cycles, no | 6 Cycles | ≥30,000 |
| Examples | | | | shedding of the | cracking or | | times |
| | | | | coating after | shedding of the | | |
| | | | | three cycles | coating | | |
| | 2 | 9H | Grade 1 | No blistering | 10 Cycles, no | 4 Cycles | ≥30,000 |
| | | | | shedding of the | cracking or | | times |
| | | | | coating after | shedding of the | | |
| | | | | three cycles | coating | | |
| | 3 | 9H | Grade 1 | No blistering or | 10 Cycles, no | 6 Cycles | ≥30,000 |
| | | | | shedding of the | cracking or | | times |
| | | | | coating after | shedding of the | | |
| | | | | three cycles | coating | | |
| | 4 | 9H | Grade 1 | No blistering or | 10 Cycles, no | 5 Cycles | ≥30,000 |
| | | | | shedding of the | cracking or | | times |
| | | | | coating after | shedding of the | | |
| | | | | three cycles | coating | | |
| | 5 | 9H | Grade 1 | No blistering or | 10 Cycles, no | 4 Cycles | ≥30,000 |
| | | | | shedding of the | cracking or | | times |
| | | | | coating after | shedding of the | | |
| | | | | three cycles | coating | | |
| | 6 | 9H | Grade 1 | No blistering or | 10 Cycles, no | 5 Cycles | ≥30,000 |
| | | | | shedding of the | cracking or | | times |
| | | | | coating after | shedding of the | | |
| | | | | three cycles | coating | | |

As can be seen from Table 3, in the preparation process of the silicone oil microcapsule, the selection and amount of silane are very important. When the mass ratio of trifunctional silane to difunctional silane is 1:1-2:1, the silicone oil microcapsule formed has a regular structure and an appropriate pore size, so that the silicone oil can be gradually and slowly released during use 5 with heating to continuously provide the coating with the non-stick property, and thus the non-stick durability of the coating is excellent. When the selection and amount of silane are inappropriate, the silicone oil microcapsule formed has an undesirable structure, resulting in poor non-stick durability of the coating.

The above describes the specific embodiments of the present application. It is to be 10 understood that the present application is not limited to the specific embodiments described above, and that various variations and modifications within the scope of the claims may be made by those skilled in the art without affecting the spirit of the present application.

What is claimed is:

1. A non-stick ceramic coating composition, comprising a primer and a top coating, wherein:
based on a total weight of the primer being 100%, the primer comprises the following components:
silica sol: 26-28%, 1% NaOH solution: 4-5%, pigment: 10-12%, filler: 8-10%, dispersant: 1-1.5%, silane: 28-30%, isopropanol: 3-3.5%, silicone oil microcapsule: 3-4%, 25% formic acid solution: 0.7-1%, a balance being deionized water;
based on a total weight of the top coating being 100%, the top coating comprises the following components:
silica sol +silane: 82-85%, silicone oil microcapsule: 6-8%, leveling agent: 1-1.5%, 25% formic acid solution: added until a pH value of the top coating is the same as that of the primer, a balance being isopropanol; wherein a mass ratio of the silica sol to the silane in the silica sol +silane is 1.5-1.2:1.

2. The non-stick ceramic coating composition according to claim 1, wherein based on a total weight of the silicone oil microcapsule in the primer and the top coating being 100%, the silicone oil microcapsule comprises the following components: silicone oil: 43-45%, silane: 48-50%, cationic surfactant: 4-4.5%, a balance being the 25% formic acid solution.

3. The non-stick ceramic coating composition according to claim 2, wherein the silane in the silicone oil microcapsule is composed of a trifunctional silane and a difunctional silane in a mass ratio of 1:1-2:1; the silicone oil is at least one selected from a group consisting of: methyl silicone oil and hydroxyl silicone oil; and the cationic surfactant is a surfactant with an organic quaternary ammonium salt structure.

4. The non-stick ceramic coating composition according to claim 3, wherein the cationic surfactant comprises one or more selected from a group consisting of: cetyltrimethylammonium bromide, stearyldimethylbenzylammonium chloride, benzalkonium chloride, and benzalkonium bromide.

5. The non-stick ceramic coating composition according to claim 2, wherein the silicone oil microcapsule in the primer and the top coating is prepared by: uniformly mixing the silicone oil, the silane, and the cationic surfactant, adjusting a pH value of a resulting mixture to 4.0-5.0 with the 25% formic acid solution with stirring, reacting for 4-6 h, and then sonicating for 2 h to obtain the silicone oil microcapsule in the primer and the top coating.

6. The non-stick ceramic coating composition according to claim 1, wherein the silane in the primer and the top coating is selected from one or more selected from a group consisting of: methyl trimethoxysilane, methyl triethoxysilane, dimethyl dimethoxysilane, and dimethyl diethoxysilane.

7. The non-stick ceramic coating composition according to claim 1, wherein the silica sol and the silane in the primer and the top coating are of a same type and in a same ratio.

8. The non-stick ceramic coating composition according to claim 1, wherein the pigment is an inorganic pigment; and the filler is one or more selected from a group consisting of: mica powder, silica micropowder, kaolin, alumina powder, and fumed silica.

9. A method for preparing of the non-stick ceramic coating composition according to claim 1, comprising the following steps:
A1, preparing a color paste of the primer by: uniformly mixing the silica sol, the pigment, the filler, the dispersant, and the deionized water in the primer, adjusting a pH value of a resulting mixture to 9.5-10.5 with the 1% NaOH solution, and then grinding the resulting mixture to a fineness of less than 20 μm;
A2, preparing the primer of the non-stick ceramic coating composition by: uniformly mixing the silane, the isopropanol, the silicone oil microcapsule, and the 25% formic acid solution in the primer, then adding the color paste prepared in step Al, uniformly mixing, and reacting for 4-8 hours to obtain the primer of the non-stick ceramic coating composition; and
A3, preparing the top coating of the non-stick ceramic coating composition by: uniformly mixing the silane, the isopropanol, the silicone oil microcapsule, and the leveling agent in the top coating, gradually adding the 25% formic acid solution, measuring a pH value of a resulting solution and adjusting the pH value to be the same as that of the primer, then adding the silica sol, uniformly mixing, reacting for a same time as the primer, and then measuring the pH value every half an hour until the pH value is stable to obtain the top coating of the non-stick ceramic coating composition.
